(19) United States
(12) Patent Application Publication
(10) Pub. No.: US 2026/0070210 A1
(43) Pub. Date: Mar. 12, 2026

(54) Modular Tool Storage System for Aerial Lift Platforms and Method for the Same

(71) Applicant: SYSTEME'D INC., Wickham (CA)

(72) Inventor: Guyllaum Deneault, Wickham, QC (CA)

(21) Appl. No.: 19/321,750

(22) Filed: Sep. 8, 2025

Related U.S. Application Data
(60) Provisional application No. 63/691,707, filed on Sep. 6, 2024.

(51) Int. Cl. B25H 3/04; B25H 3/02

(52) U.S. Cl. CPC B25H 3/04; B25H 3/02

(57) ABSTRACT

The invention relates to a modular tool storage system specifically designed for use on aerial lift platforms. The system includes adjustable mounting supports that can be securely attached to the lift platform's railing and floor, providing a stable base for various storage units, such as toolboxes and modular PackOut™ units. The mounting supports feature horizontal and vertical extensions, along with reinforcement plates, ensuring the system's strength and stability under load. The system can be configured in multiple ways, including options for storing long objects outside the platform, optimizing workspace efficiency. The design allows for easy access to tools and materials while enhancing safety by keeping the platform organized and free of clutter. The invention's adaptability and robust construction make it an ideal solution for workers who need a reliable, customizable storage system while working at heights.

### CROSS-REFERENCE TO RELATED APPLICATIONS

The present patent application claims the benefits of priority of United States Provisional Patent Application No. 63/691,707, entitled “MODULAR TOOL STORAGE SYSTEM FOR AERIAL LIFT PLATFORMS AND METHOD FOR THE SAME”, and filed at the United States Patent and Trademark Office on September 6, 2024, the content of which is incorporated herein by reference.

### FIELD OF THE INVENTION

The present invention generally relates to modular tool storage systems and methods for lift systems. More particularly, the present invention relates to modular tool storage systems and methods that can be securely attached to the railings and floors of lift baskets used by workers operating at heights.

### BACKGROUND OF THE INVENTION

In many industries, workers are required to perform tasks at elevated heights using lift baskets or aerial work platforms. These environments present challenges in organizing and accessing tools during work. Such environments generally impact both safety and productivity of the workers. Conventional tool storage solutions are often inadequate, either because they are not securely attached to the lift baskets or because they do not provide the modularity and flexibility required to accommodate different tools and materials. Furthermore, known systems to store tools or material on aerial basket or pods do not provide flexibility in operation and often take up important areas of the floor of the backet. As the floor area is limited for pods and baskets, having optimized storage mechanisms become an important issue.

Existing systems also fail to provide a standardized interface for integrating with known attachment systems, such as but not limited to the Milwaukee PackOut™ system. Therefore, there is a need for a modular, adjustable, and robust tool storage system that can be securely mounted to the lift baskets while offering easy access and adaptability to different tools and materials and limiting the actual surface used on the floor area.

### SUMMARY OF THE INVENTION

The shortcomings of the prior art are generally mitigated by providing a modular tool storage system securely mounted to railings and floor of a lift basket or pod. The system includes adjustable and robust storage units that enhance the efficiency and safety of workers. The invention is also designed to be compatible with existing or standard attachment systems such as but not limited to the Milwaukee PackOut™ system.

The present invention aims at improving efficiency of any type of worker using a lift pod and is not limited to a specific type of worker, such as electrician, carpenter, plumber, or any other worker in the field of construction.

The present invention generally aims at enhancing the safety, efficiency, and practicality of accessing tools and materials during elevated work operations.

The modular tool storage system includes various components such as horizontal and vertical supports, cross-members, and specialized attachment points. These components can be assembled and adjusted to create a customized tool storage solution that fits the specific needs of the worker and the task at hand.

In an aspect of the present invention, a modular storage system for an aerial lift platform is provided. The system comprises a self-supporting lower structure comprising at least two legs adapted to sit on a floor of the aerial lift platform, two vertical support members extending from the self-supporting lower structure and at least one support assembly detachably attached to the two vertical support members.

The support assembly may comprise a frame which comprises an attachment member mating with an attachment member of the vertical support member. The attachment member of the frame may be a head pin protruding away from a vertical member of the support assembly and the attachment member of the vertical support member being an aperture adapted to receive and retain the head pin. The modular storage system may further comprise a storage box mounted to the support assembly. The storage box may comprise a frame, side walls attached to the frame; a cover; and a front door.

The self-supporting lower structure may comprise two side frames attached one to another by a horizontal support member, the two side frames being attached to the two vertical support members. The two side frames may be attached to the two vertical support members to allow attachment member of the vertical support members to be accessible to mount the support assembly.

The modular storage system may further comprise a second support assembly mounted to the two vertical support members over or under the first support assembly. The system may comprise mounting brackets adapted be a to retain the modular storage system to rails or other portion of the aerial lift platform.

The support assembly may comprise an underneath hanging attachment assembly fixed to sides of support assembly. The underneath hanging attachment assembly may comprise an attachment bracket mounted to a horizontal support of the support assembly forming a passage between a lower portion of the horizontal support and the bracket.

The support assembly may be square and may comprise a reinforcement member attached at a horizontal support and a vertical support.

In another aspect of the invention, a modular storage system for an aerial lift platform is provided. The modular storage system comprises two vertical support members adapted to be supported by the aerial lift platform, mounting brackets adapted to mount the vertical support members to rails or other portion of the aerial lift platform and at least one support assembly detachably attached to the two vertical support members.

The support assembly may comprise a frame which comprises an attachment member mating with an attachment member of the vertical support member.

In yet another aspect of the invention, a method for storing tools and/material on an aerial lift platform is provided. The method comprises disposing a self-supporting storage system on a surface of the aerial lift platform, detachably mounting a support assembly to vertical support assemblies of the self-supporting storage system and storing the tools or materials on the support assembly.

The method may comprise detaching the mounted support assembly and attaching the detached mounted support assembly to another predetermined position of the vertical support assemblies.

The method may further comprise detachably mounting a second support assembly to the vertical support assemblies over or under the mounted support assembly. The method may further comprise mounting the vertical support assemblies to rails or other portion of the aerial lift platform. The mounting of the vertical support assemblies may use mounting brackets attachable to the rails or other portion of the aerial lift platform.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an embodiment of a modular storage system mounted on a lift platform according to the principles of the present invention.

FIG. 2 is a perspective view of a mounting support bracket of the modular storage system of FIG. 1.

FIG. 3 is a bottom view of the mounting support and brackets of FIG. 2.

FIG. 4 is a rear elevation view of the mounting support and brackets of FIG. 2.

FIG. 5 is a right-side elevation view of the mounting support and brackets of FIG. 2.

FIG. 6 is perspective view of an embodiment of a modular mounting support comprising a mounting system according to the principles of the present invention.

FIG. 7 is a top plane view of the mounting support of FIG. 6.

FIG. 8 is a left-side elevation view of the mounting support of FIG. 6.

FIG. 9 is a front elevation view of the mounting support of FIG. 6.

FIG. 10 is perspective view of an embodiment of a foldable material holding bracket attachable to a railing of a lift backet according to the principles of the present invention.

FIG. 11 is a rear elevation view of the material holding bracket of FIG. 10.

FIG. 12 is a side elevation view of the material holding bracket of FIG. 10 shown in a folded configuration.

FIG. 13 is a left-side elevation view of the material holding bracket of FIG. 10 shown in a deployed configuration.

FIG. 14 is a left-side elevation view of the material holding bracket of FIG. 10 shown in a L-folded configuration.

FIG. 15 is a left-side elevation view of the material holding bracket of FIG. 10 shown in a S-folded configuration.

FIG. 16 is perspective view of an embodiment of a floor supporting member according to the principles of the present invention.

FIG. 17 is a right-side elevation view of the floor supporting member of FIG. 16.

FIG. 18 is a rear elevation view of the floor supporting member of FIG. 16.

FIG. 19 is a right-side elevation view of the floor supporting member of FIG. 16.

FIG. 20 is perspective view of an embodiment of a mounting bracket according to the principles of the present invention.

FIG. 21 is a right-side elevation view of the floor supporting member of FIG. 20.

FIG. 22 is perspective view of an embodiment of a mounting support assembly comprising floor supporting members and mounting brackets according to the principles of the present invention.

FIG. 23 is a front elevation view of the mounting support assembly of FIG. 22.

FIG. 24 is perspective view of another embodiment of a mounting support assembly comprising floor supporting members and mounting brackets having a vertical connecting assembly according to the principles of the present invention.

FIG. 25 is a front elevation view of the mounting support assembly of FIG. 24.

FIG. 26 is a top plane view of the mounting support assembly of FIG. 24.

FIG. 27 is a side elevation view of the mounting support assembly of FIG. 24.

FIG. 28 is perspective view of an embodiment of a storage box according to the principles of the present invention.

FIG. 29 is perspective view of embodiment of a mounting support assembly comprising a storage box according to the principles of the present invention.

FIG. 30 is a left-side elevation view of the mounting support assembly of FIG. 29.

FIG. 31 is a front elevation view of the mounting support assembly of FIG. 29.

FIG. 32 is perspective view of another embodiment of a self-standing mounting support assembly comprising a storage box according to the principles of the present invention.

FIG. 33 is perspective view of the self-standing mounting support assembly o FIG. 32 further comprising a standard connecting system.

FIG. 34 is perspective view of another embodiment of a self-standing mounting support assembly comprising a working area and a standard connecting system according to the principles of the present invention.

FIG. 35 is perspective view of another embodiment of a self-standing mounting support assembly comprising a vertical standard connecting system according to the principles of the present invention.

### DETAILED DESCRIPTION OF THE INVENTION

A novel modular tool storage system for aerial lift platforms and method for the same will be described hereinafter. Although the invention is described in terms of specific illustrative embodiments, it is to be understood that the embodiments described herein are by way of example only and that the scope of the invention is not intended to be limited thereby.

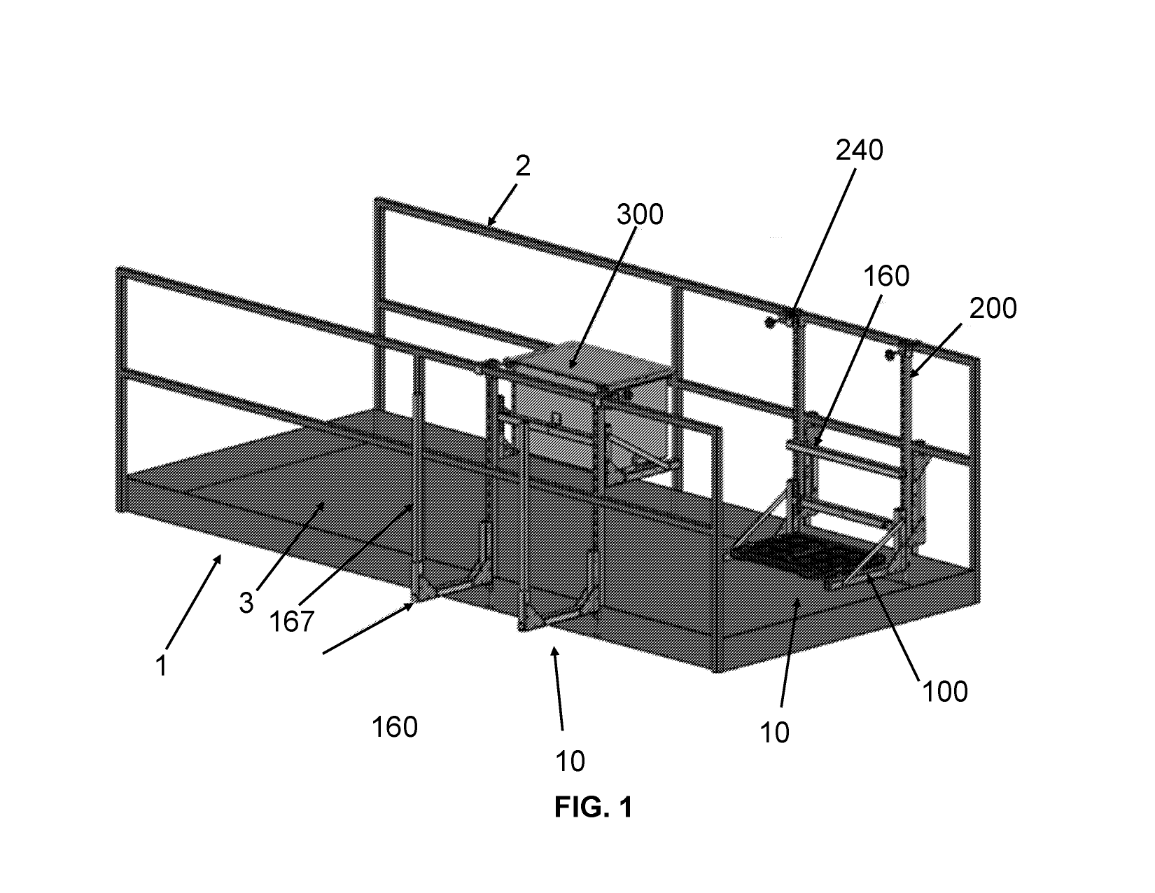

First referring to FIG. 1, an embodiment of modular tool storage system for aerial lift platforms 10 is illustrated. The system 10 generally aims at creating a secure and modular storage solution for tools, materials and equipment on a lift or pod platform. The system 10 may be configured to fulfill the specific needs of the worker. The system 10 comprises a plurality of modules which generally and individually aim at enhancing functionality and safety of the platform, allowing workers to organize their tools efficiently while minimizing the risk of accidents or tools being misplaced or dropped.

FIG. 1 illustrated a platform 1 having rails 2. The system generally comprises a mounting support assembly 100 supported by a pair of legs 200 and mounted to the rail using mounting brackets 240. The mounting support 100 is generally designed to receive a load or to support a storage assembly 300, such as a box. The storage assembly may comprise a standard connecting system 140 adapted to receive the storage box or other storage means. The connecting system 140 may be embodied as a PackOut™ unit.

The system 10 may further comprise one or more material holding brackets 160. In the illustrated embodiment, two material holding brackets mounted to the railing 2 of the platform 1 to protrude away from the said railing 1. The brackets 160 are mounted spaced apart at a distance allowing the reception of material. As examples, the brackets 162 may be adapted to receive wood pieces or boards of material used to complete the work. The brackets 160 are typically made of rigid material to support a load. Each of the material holding brackets 160 may be foldable.

The exterior mounting brackets 160 may be connected to the legs 200 from outside of the platform 1 or may be connected to the railing using mounting brackets 240. The mounting brackets may further comprise one or more elongated members 160, such as tubes, vertically extending to create a barrier with the bottom portion and the railing 2 of the platform 1. As discussed above, the brackets 160 generally aim at storing long objects, such as wooden planks, near the workspace without occupying valuable space on the lift platform 1 itself. The external storage solution may thus enhance the functionality of the system, allowing workers to have large materials within reach while keeping the platform surface clear for movement and other tasks.

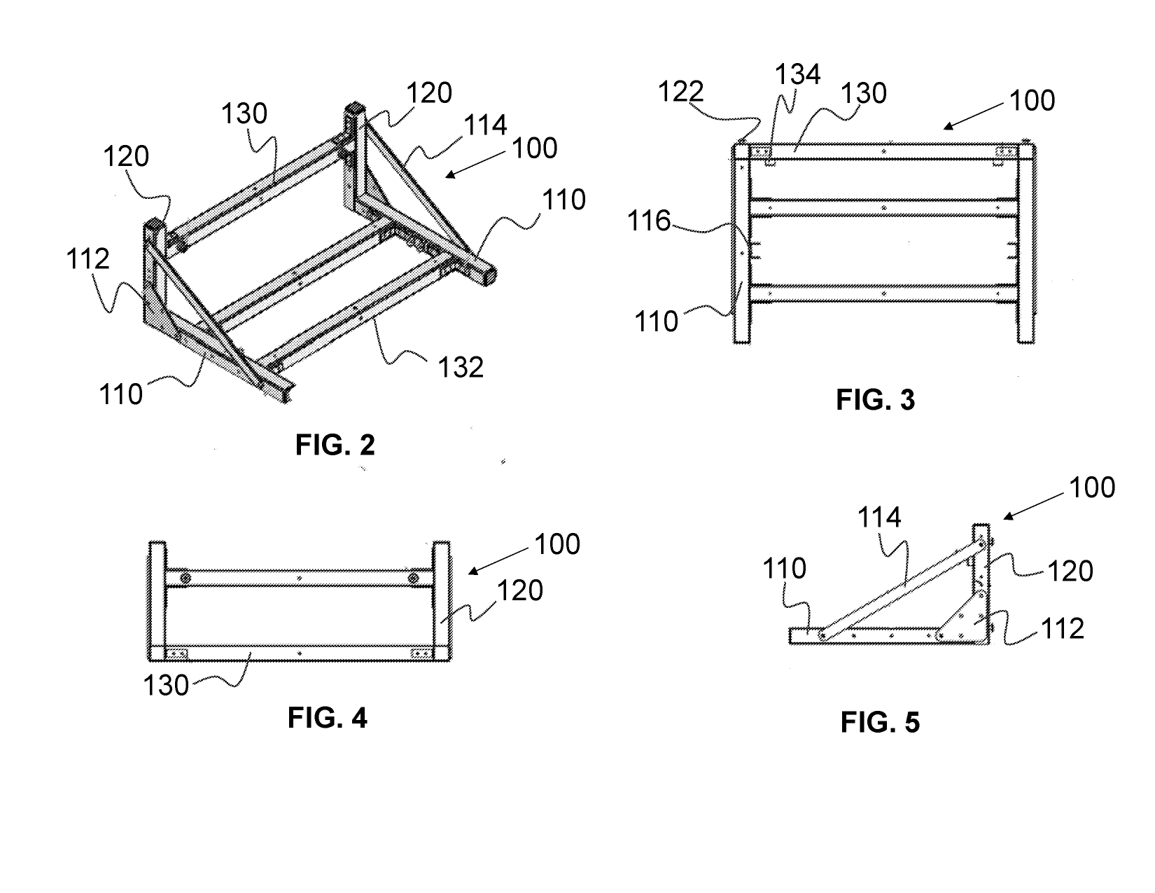

Referring now to FIGS. 2-5, an embodiment of a mounting support 100 is shown. The mounting support 100 may be used to hold an object such as a box 300 or a connecting member assembly 140 at an elevation with respect to the lift platform 1. In such embodiment, the mounting support 100 comprises a pair of horizontal supports 110, a pair of vertical members 120 fixed at an angle to the horizontal supports 110, and at least one traverse member 130 attached between the vertical members120 and/or other travers members 132 attached between the horizontal support members110. The horizontal support member 130 may further comprise attachment members or fasteners 134 to receive and hold the box 300 or other attachable assembly.

In further embodiments, the mounting support 100 may further comprise support plates 112 and reinforcement members 114. The support plates 112 may be shaped as a triangle and may be made of rigid material. In some embodiments, the support plate 112 may be pivotally attached to the horizontal support members 110 or to the vertical members 120. The reinforcement members 114 may be made of rigid material and may have an elongated shape, having one end attached to the horizontal support member 110 and the opposite end to the vertical member 120. The support plate 112 and/or reinforcement members 114 generally ensure that the assembly can withstand predetermined load applied on the mounting structure and are placed at strategic points in the frame, such as near joints or high-stress areas, to provide additional support and ensure that the assembly can handle heavy loads without deforming or failing.

The mounting support structure 100 further comprise attachment points 122 adapted to be connected to the legs 200. In the illustrated embodiment, the attachment fasteners 122 are embodied as a head pin with the head protruding away from the vertical support member 120. Understandably, the attachment fasteners could be attached to the horizontal support member 130. In the illustrated embodiment, the head pin is slidingly received and retained by a matching aperture 212 of the leg 200.

The mounting support structure 100 may further comprise U brackets 116 adapted to receive an attachment member, such as a rubber strap (not shown). The rubber strap may comprise a protuberance receivable by the C-shape bracket 342 of the box. Understandably, the U bracket 116 may be replaced with any other type of attachment system to hold the box to the mounting support assembly 100.

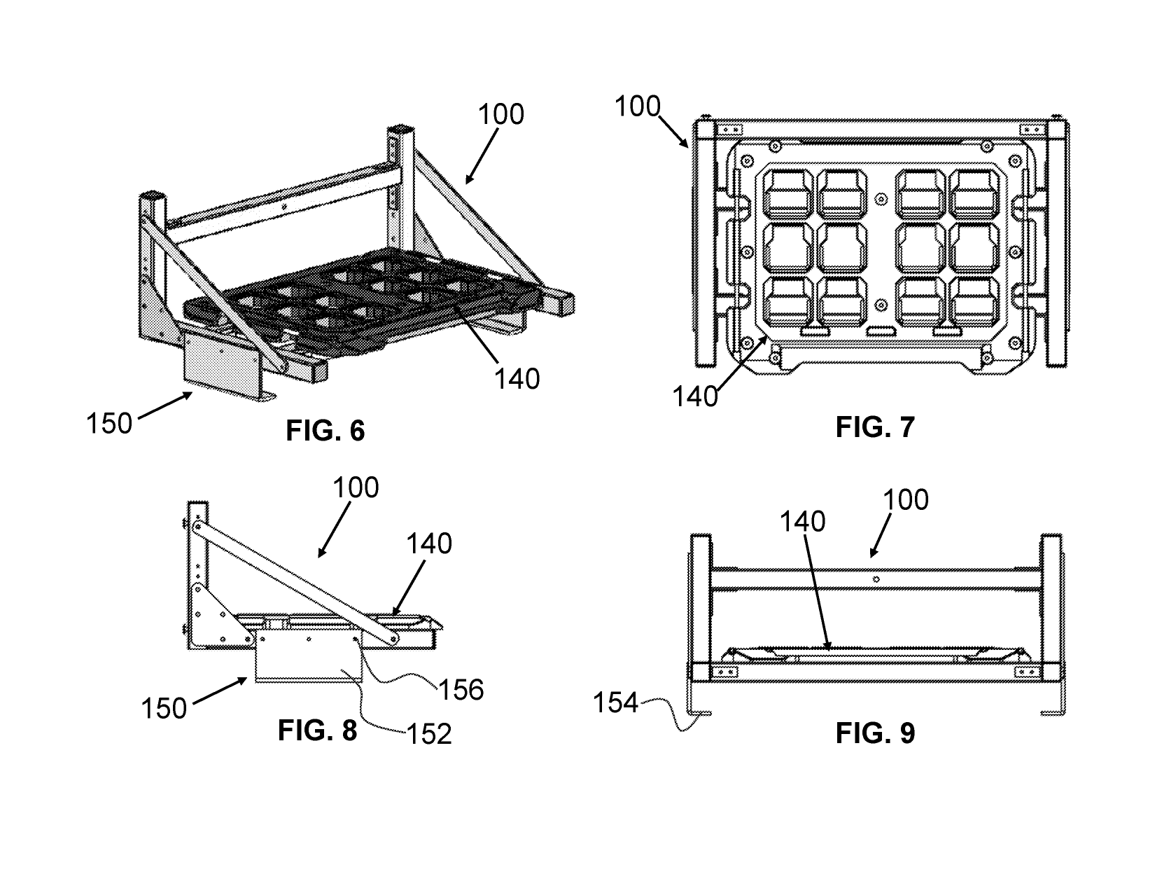

Referring now to FIG. 6-9, an embodiment of a mounting support 100 comprising a tool connector assembly 140 is shown. As discussed above, a PackOut™ assembly is illustrated but any type of tool connector assembly 140 may be used. The tool connector assembly 140 is mounted or fixed to the he horizontal supports members 132 with any type of fasteners or attachment system. In further embodiments, the mounting support 100 may further comprise an underneath attachment member 150 fixed to the sides of the horizontal supports 110. The underneath attachment member 150 may be used to hang, for example, a box 300 or any other additional tool. In the illustrated embodiment, the underneath attachment member 150 may comprise an attachment plate 152 mounted to the horizontal support 110. The attachment plate 152 may be vertically positioned and may comprise aperture 156 for fastening the said attachment member 150 to the horizontal support 110. A suspending plate 154 extend at an angle from the attachment plate 152 and is preferably positioned horizontally. The suspending plate 154 receives the box 300 or tool to be suspended.

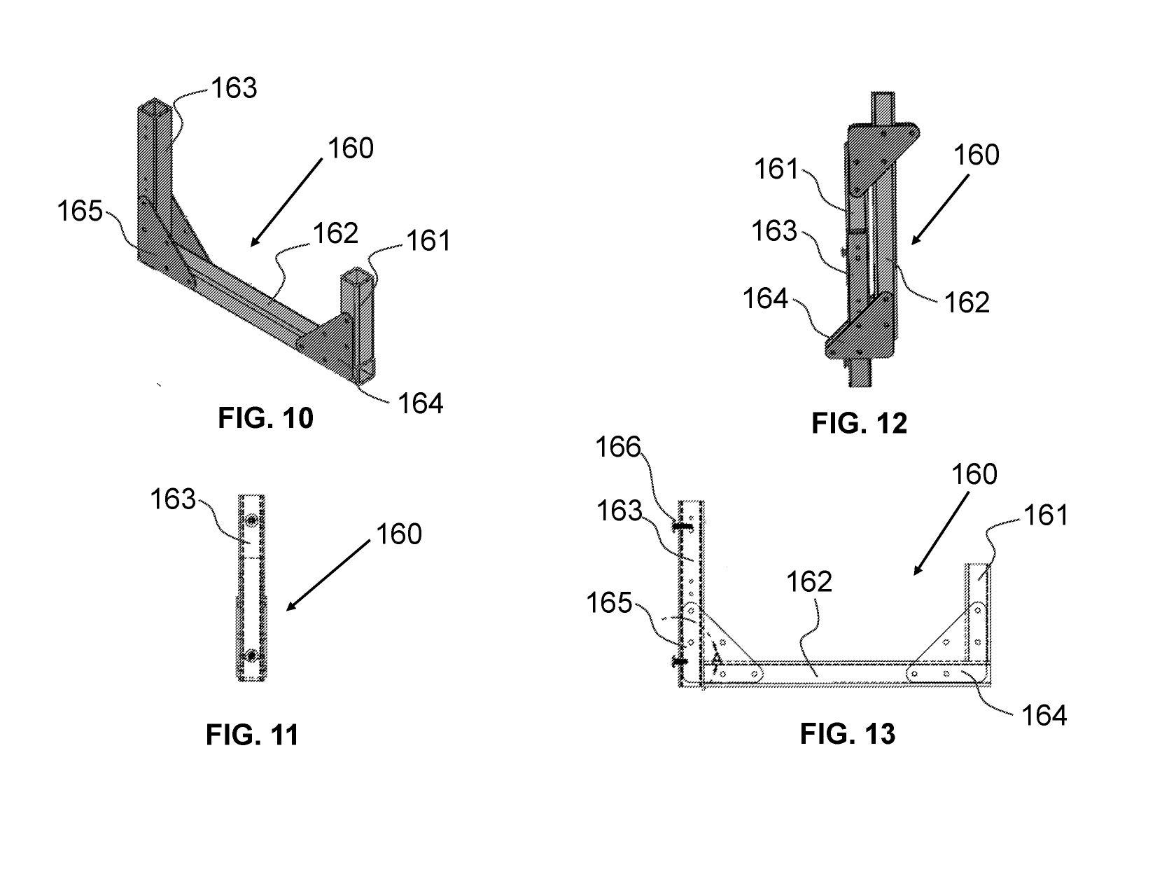

Referring now to FIGS. 10-13, an embodiment of a material holding brackets 160 is illustrated. The material holding brackets 160 is typically attached to the rail 2 to extend away from the exterior of the platform 1. Each of the holding brackets 160, when mounted to the rail 2, generally create a U-shape section adapted to receive materials. In the illustrated embodiment, the exterior bracket 160 comprises two substantially vertical members, a first member 161 and a second member 163, the first member 161 being shorter than the second member 163. The vertical members 161 and 163 being attached to the substantially horizontal member 162. In some embodiments, as illustrated, the vertical members 161 and 163 may be pivotally attached to the horizontal member 162. The second vertical member 163 comprises an attachment member 166 adapted to be received and retained to the leg 200. In the illustrated embodiment, the attachment member 166 is a head pin receivable by a matching aperture 212 of the leg. Understandably, any means to attach the second vertical member 163 may be used within the scope of the present invention.

In some embodiment, an additional vertical member 167 may be fixed or inserted in the second vertical member 163 to extend away vertically as a continuation or extension of the second vertical member 163. Such extension generally aims at enabling the secure storage of large objects, such as but not limited to long planks of wood or plywood, panel, covering and/or pipes, outside the lift platform but within easy reach of the workspace. Understandably, in other embodiments, the extending member 167 may be integral with the second member 163.

The vertical members 161 and 163 and the horizontal member 162 form a rigid structure that can handle the weight and length of the stored items without compromising stability or safety. I

In the embodiment shown in FIG. 12, the material holding brackets 160 is shown in a folded configuration. The folded configuration generally allows the system to be compact and thus limiting the surface or volume occupied by the lift platform. As such, it may allow the platform to get closer to a wall, structure and/or building compared to the deployed configuration. In such embodiment, the first vertical member 161 is folded about an axis created by the pair of mounting plates 164. In such embodiment, a bolt and a nut (not shown) may be inserted through an aperture of the mounting plates 164 and of the first member 161 to create a pivot axis. Similarly, the second vertical member 163 may be folded about an axis created by the pair of mounting plates 165. In such embodiment, a bolt and a nut (not shown) may be inserted through an aperture of the mounting plate 165 and of the first member 163 to create a pivot axis. In use, the extension member 167 (if present) are removed and the first and second members 161 and 163 are pivot to create a folded configuration, generally aiming at reducing the volume of the said material holding brackets 160 when not in use.

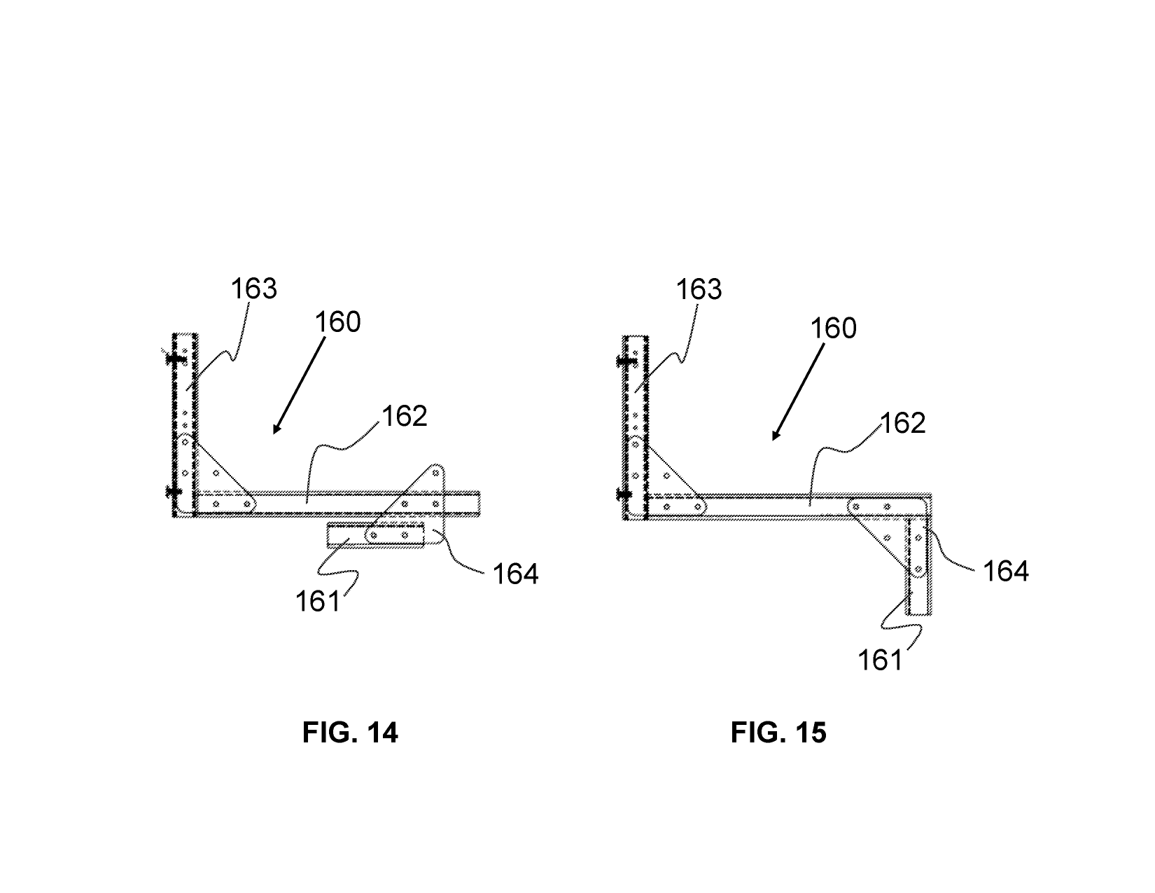

Referring now to FIGS. 14-15, another embodiment of the material holding brackets 160 is illustrated shown with the first vertical member 161 pivoted or mounted externally to create a flat bracket. In the illustrated embodiment, the first vertical member 161 is pivoted or the mounting plates 164 are pivoted in relation to the horizontal member 162 so the first vertical member 161 is positioned substantially parallel to the horizontal member 162. This configuration which may be necessary for specific applications or workspace constraints. The inverse orientation of the material holding brackets 160 still provides the same functionality and load-bearing capabilities as the standard configuration but offers additional flexibility in how the system can be installed and used in different environments. It may allow, as an example, to receive a box or other component on a substantially flat surface.

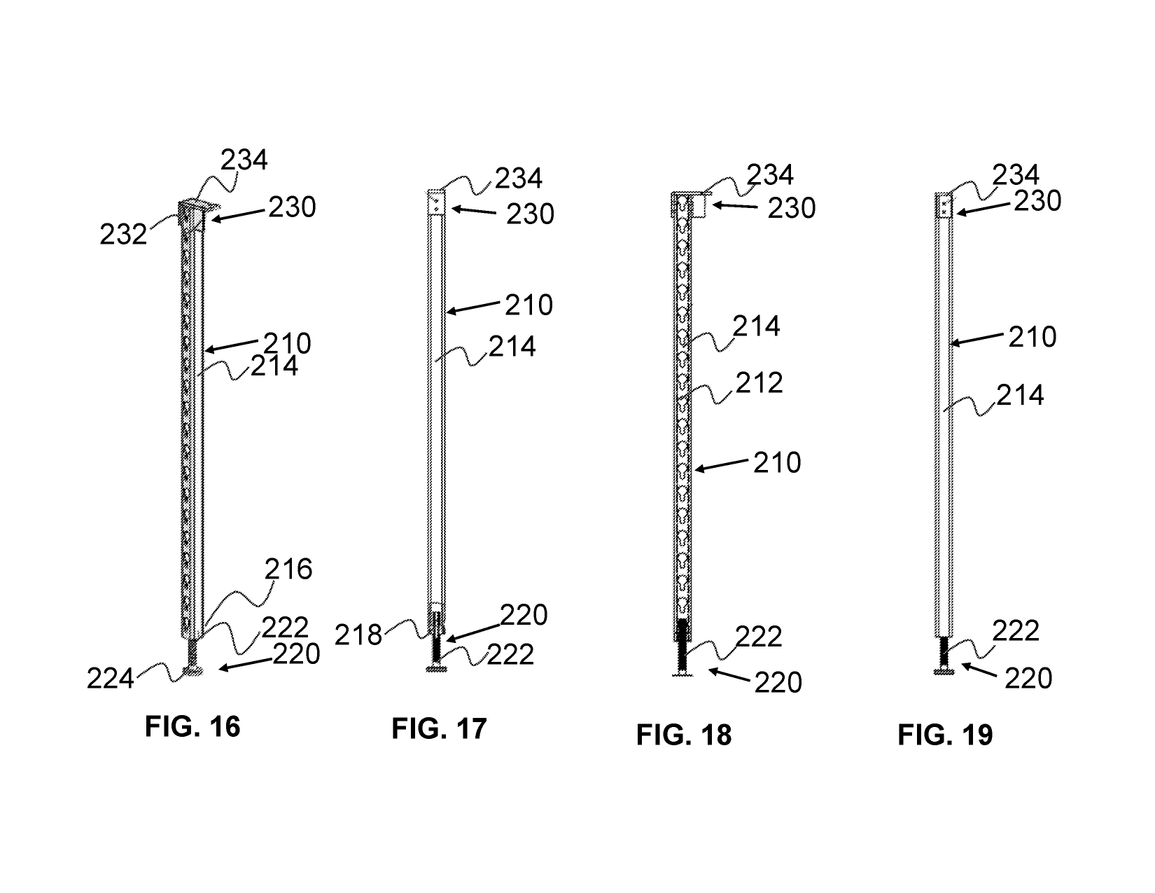

Referring now to FIGS. 16-19, an embodiment of a floor supporting leg 200 is shown. At one end, the leg 200 is supported by the floor 3 of the platform 1 and at another end, the leg 200 is attached to the rail 2 of the platform. The leg 200 further comprise attachment points or anchors 212 adapted to receive and retain different modules, such as the mounting support 100 or the material holding bracket 160.

In the illustrated embodiment, the leg 200 comprises an elongated member 210, a foot 220, and a mounting portion 230. The elongated member 210 generally comprises attachments points along its length. In the illustrated embodiment, is the elongated member 210 is a long hollow piece 214 of rigid material comprising a series of holes or apertures 212 along its length. The said holes 212 may be used to attach components such as the mounting support 100 or the material holding bracket 160. As such, the holes 212 may receive the head pins 122 or 166 of the mounting support 100 or the material holding bracket 160, respectively. Understandably, any other known attachment means may be used within the scope of the present invention.

The foot 220 is adapted to support the leg 200 on the floor 3 and extend away from the bottom 216 of the elongated member 210. The foot 220 typically comprises an adjustment mechanism 222 and a supporting portion 224. The supporting portion 224 of the foot 220 is generally designed to stay in contact with the floor 3 of the lift platform 1 and to support the load of the leg 200 and attached modules. The adjustment mechanism 222 may be embodied as threaded member received by a threaded aperture 218 of the elongated member 210. As such, by turning the foot 220 clockwise or counterclockwise, the length of the leg 200 may be reduced or extended. Understandably, any other mean to extend the length of the elongated member 210 while supporting the load may be contemplated within the scope of the present invention.

The mounting portion 230 is used to attached the top of the leg 200 to the rail 2 of the platform 1, typically using a mounting bracket 240, such as the bracket 240 shown in FIG. 15. In the illustrated embodiment, the mounting portion 230 comprises a push plate 232 fixed to the top portion of the leg 200, such as fixed to a top portion of the elongated member 210. The push plate 232 extends away from a side of the elongated member 210 to provide a surface for the mounting bracket 240 to push the said plate 232 against the rail 2. The mounting portion 230 may further comprise a top plate 234 to which the push plate 232 is affixed.

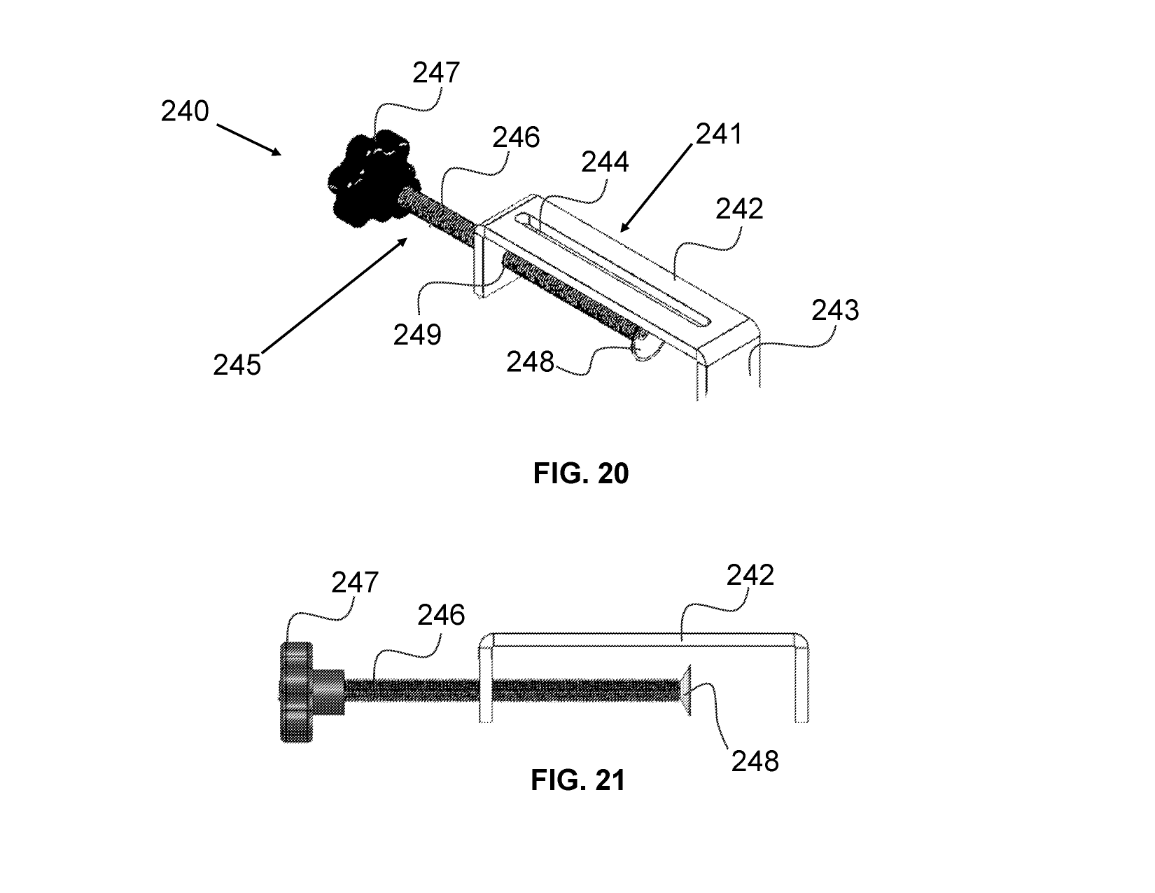

Referring now to FIGS. 20 and 21, an embodiment of the mounting bracket 240 is illustrated. The mounting bracket is adapted to detachably retain the leg 200 against the rail 200 of the platform. The mounting bracket is adjustable to any type of rail 2 and of leg 200. In the illustrated embodiment, the mounting bracket 240 comprises a rigid frame 241 and push member 245. The rigid frame 241 comprises a top surface 242 and two side wall 243. The top surface 242 may comprise an aperture 244 allowing a user to position the push member 245 against the rail 2. The pus member 245 generally comprise a threaded rod 246, a handle 247, and a push portion 248 adapted to push against the rail 2. The rod 246 passes through a threaded aperture 249 of the frame 241 and may be tightened or untightened using the handle 247. As such, the push portion 248 (or foot) moves toward or away from the rail 2 and can be securely pushed against the said rail 2. Understandably, any other known mechanism or bracket allowing to secure the leg 200 against the rail 2 may be used within the scope of the present invention. The legs 200 may be positioned in such a way that they provide a stable and adjustable support for the box 300 or other components mounted on the lift platform 1.

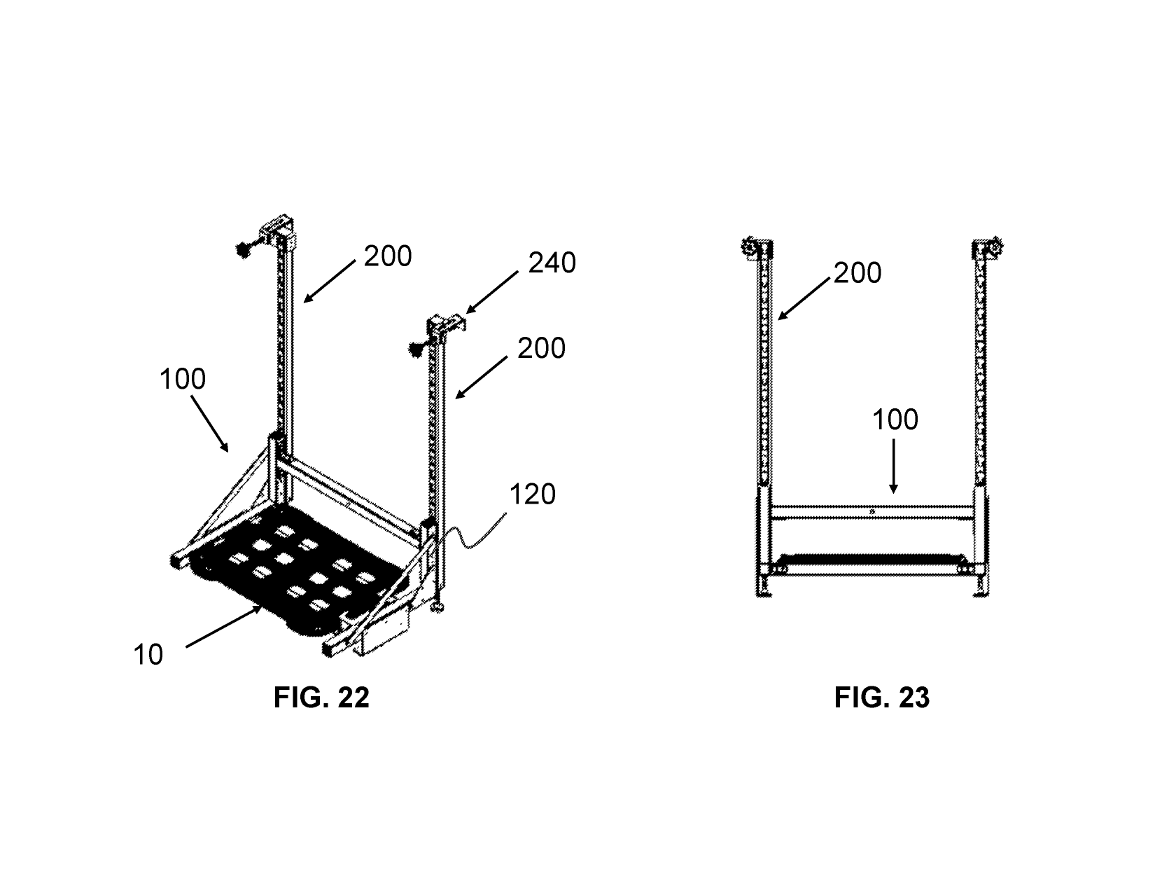

Referring now to FIGS. 22-23, a mounting support 100 attached to leg assemblies 200 is shown. The vertical member 120 of the mounting support 100 may be attached to the apertures 212 of the pair of legs 200 using the attachment member 122. In such example, the mounting support 100 also includes a connecting member 140, such as a PackOut™ unit 140.

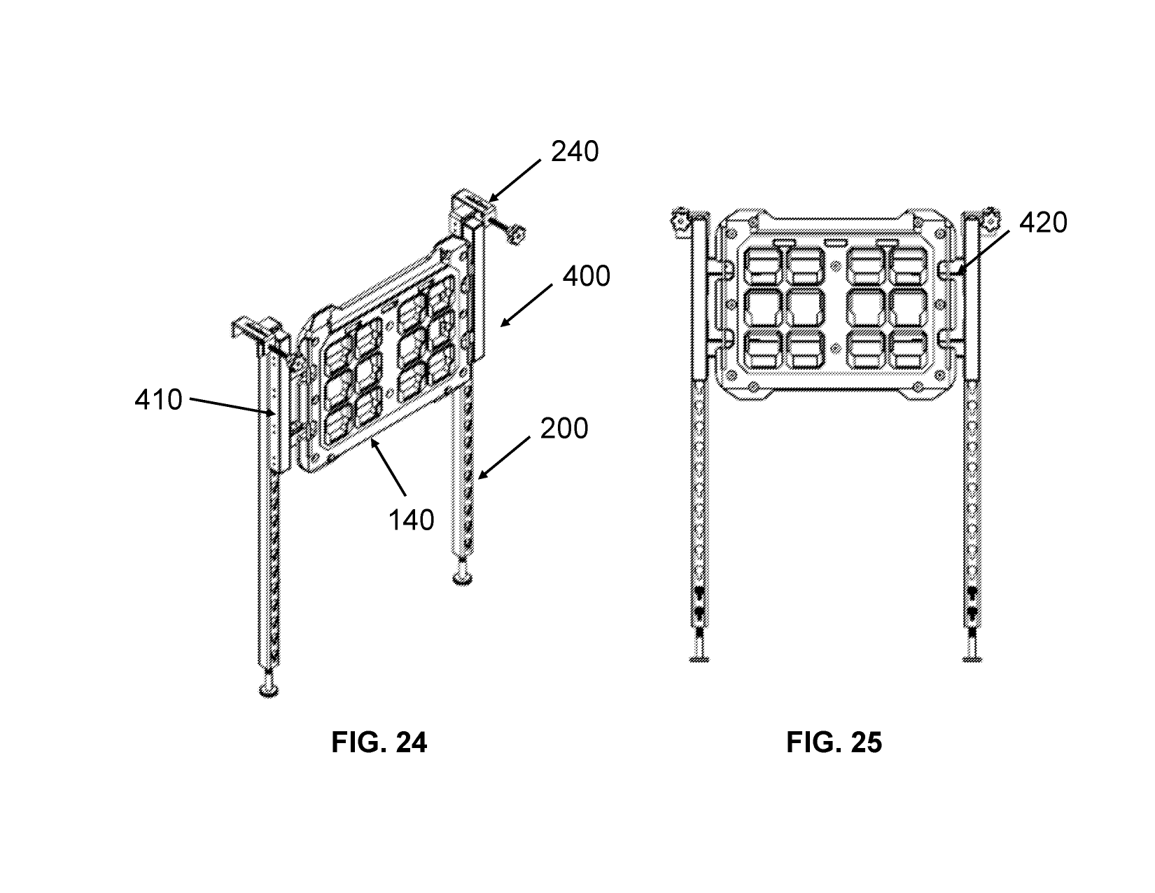

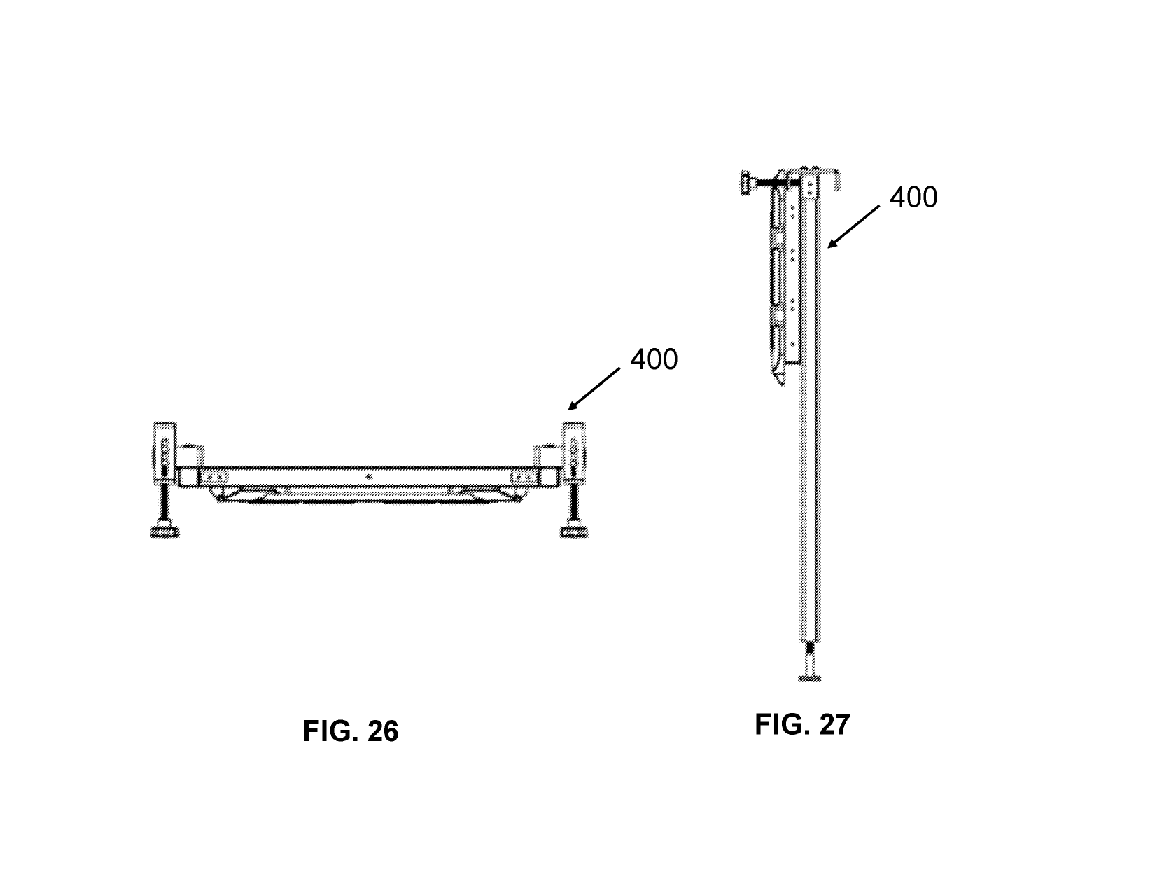

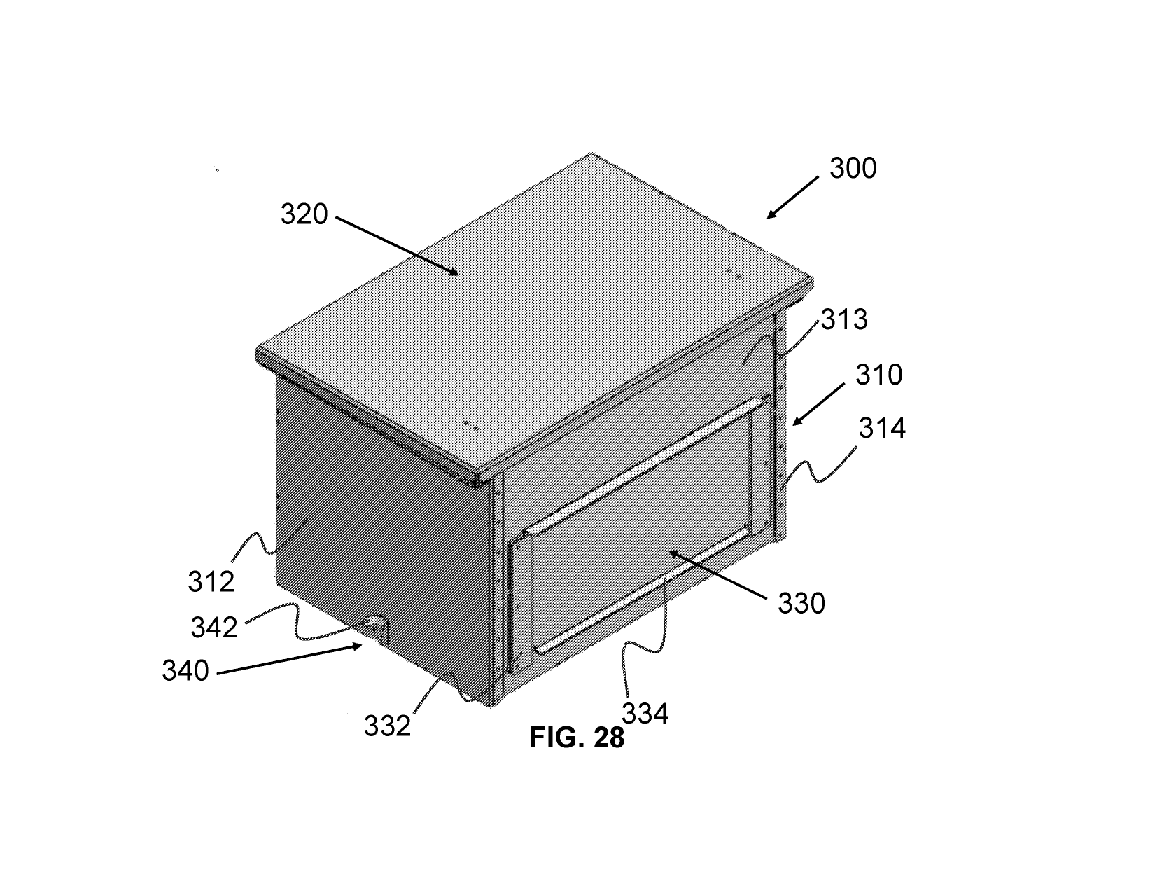

Referring now to FIGS. 24-27, an alternative embodiment of a vertical support assembly 400 is illustrated. In such embodiment, the support assembly 400 comprises vertical members 410 attachable to the leg 200, similarly to the mounting support assembly 100. The support assembly 400 further comprises horizontal members 420 attached at an angle, preferably perpendicular, to the pair of vertical members 410. In such embodiment, a tool connector assembly 140 is attached to the horizontal members 420 and allows attaching tools or a box to the tool connector assembly 140. This configuration is particularly useful in scenarios where a vertical orientation of the storage system is preferred, allowing for better accessibility and use of space within the lift platform 1.

Referring now to FIGS. 28-31, an embodiment of a storage box 300 usable with the present system 10 is shown. The box 300 may comprise a frame 310, a cover 320, a front door 330, and a mounting assembly 340. The frame 310 is the structural component of the box 300, forming the outer frame that provides rigidity and shape to the entire assembly. The frame is made of a rigid material, such a metal. In the illustrated embodiment, the frame 310 is made of aluminum 6061-T6 or any other material that provides the required structure and solidity to fit the purpose. The frame 310 may comprise side panels 312 and/or structural edges 314. The frame 310 may further be reinforced with corner brackets 314 for added stability.

The cover 320 is positioned on top of the box 300 and is pivotally attached to the frame 310. The cover 320 may be attached using a hinge or other pivoting mechanism. The cover 320 is designed to fit securely onto the frame 310. The cover is typically made of rigid material, such as the same material as the frame 310.

The box 300 may comprise a door 330 on the front face 313 of the frame 310. In the illustrated embodiment, the door 330 is slidably attached to the front panel 313 and may comprise sliders 332 attached to the frame 310. The sliders 332 allow the door 330 to smoothly move up and down. The door 330 may further comprise lip portion 334 acting as handles to ease pulling or pushing the door 330. Understandably, any type of door may be used within the scope of the present invention, such as a door with hinges to vertically or horizontally open.

The door 330 further comprises mounting assembly 340 adapted to mount the box 300 to the support mounting assembly 100. The mounting assembly 340 may be embodied as C-shape bracket 342 adapted to receive a rubber strap having enlarged extremity (not shown). In such embodiment, the rubber strap is attached to system 10, such as on the support mounting assembly 100. Understandably, any other known mounting assembly may be used within the scope of the present invention.

The box 300 may further comprise a locking mechanism (not shown) for additional security. Furthermore, the box 300 may comprise with plastic caps and door retaining angles to ensure that all components are securely held in place during operation.

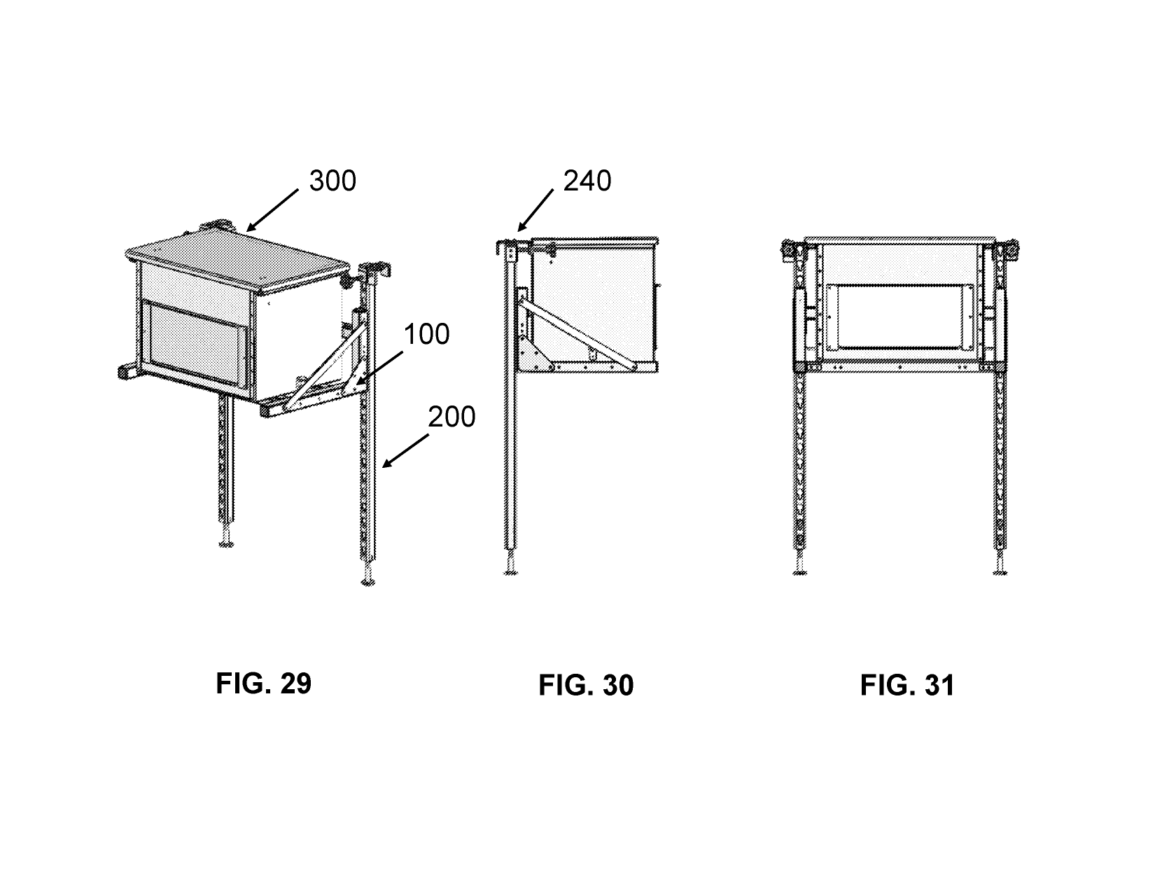

Referring now to FIGS. 29-31, the box 300 is illustrated installed to a mounting support 100 and attached to the rail 2 and supported on the floor 3 using legs 200 and mounting brackets 240. The box 300 is fixed to the mounting support 100 using the mounting assembly 340. The mounting support 100 may be adjustably fixed to the legs 200 at a height at which the box 300 is desired for a specific purpose.

A method for storing tools and/material on a lift pod is also provided. The method generally aims at optimizing and securing the storage of tools and material in the lift pod as space is limited. The method further aims at maximizing the safety and productivity of workers on the lift pod, particularly in environments where the working area is restrained and where quick access to tools is critical.

The method comprises positioning legs 200 on the floor 3 of the platform 2 and mounting the top of the legs 200 to the rail 2 of the aerial lift platform 1. The method further comprises adjusting the length of the leg 200 to adapt to the height of the rail 2 of the platform 1 and to secure the legs 200 between the rail 2 and the floor 3.

The legs 200 should generally be positioned at the desired locations along the platform's railings, ensuring they are spaced correctly to accommodate the mounting support 100. Depending on where the tool storage is needed, the legs may be installed inside the aerial lift platform 1, using the railing 2 of the platform 1, as long as the floor 3 is large enough to receive the legs 200 outside of the railing 2.

Use the U-shaped adjustment components 240 to fasten the legs 200 to the platform railing 2, tightening the rods 246 with the handles 247 until the legs 200 are stable and firmly in place. The feet 220 should rest securely on the platform 1 floor to provide additional stability.

The method further comprises attaching one or more mounting support assemblies 100 to the fixed legs 200. One shall understand that the mounting support assembly 100 shall be leveled when attached to the legs 200. In the illustrated embodiment, the head pins of the mounting support assembly 100 are slidden in the apertures 212 of the legs 200 to secure the mounting support assembly 100.

When the mounting support 100 and legs 200 are securely installed, the method may comprise connecting the desired tools or storage box 300 to the support mounting assembly 100. In an embodiment of the invention using a tool connecting assembly 140, the tools are connected to the tools connecting assembly 140 using any type of connection, such as the PackOut™ system. The method may further comprise attaching one or more material holding brackets 160 to the leg 200. Similarly to the mounting of the mounting support assembly 100, in the illustrated embodiment, the head pin of the material holding brackets may be slidden in the outer apertures 212 of the legs 200 to secure the material holding brackets 160 outside of the railing 2. The method may further comprise inserting extension members 167 in the material holding brackets or to fold the material holding brackets 160 when not in use. The method may further comprise folding the first vertical member 161 to create a different surface of the material holding bracket 160.

f the embodiment of the invention uses a box 300, the method may comprise mounting the box 300 to the mounting support 100 from the inside of the lift platform 1.

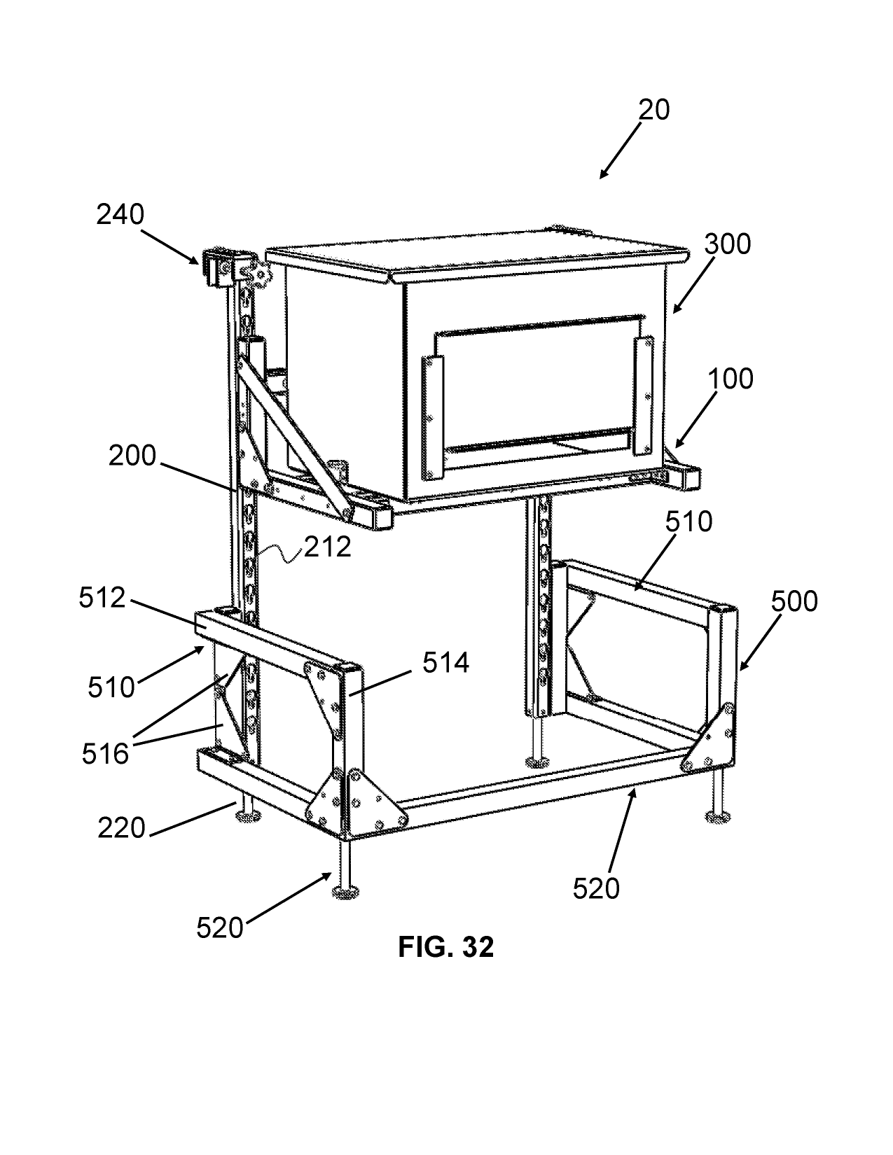

Referring now to FIGS. 32-35, another embodiment of self-supporting modular tool storage system for aerial lift platforms 20 is illustrated. The system 20 generally aims at creating a secure and modular storage solution for tools, materials and equipment on a lift or pod platform without being attached or retained by a portion of the lift platform. As for the previous embodiment, the system 20 may be configured to fulfill the specific needs of the worker. The system 20 comprises a plurality of modules which generally and individually aim at enhancing functionality and safety of the platform, allowing workers to organize their tools efficiently and in a custom fashion while minimizing the risk of accidents or tools being misplaced or dropped.

Referring now to FIG. 32, the system 20 generally comprises at least one mounting support assembly 100 supported by two vertical support members or legs 200. The mounting support 100 is generally adapted to receive a load or to support a storage assembly 300, such as a box or a standard connecting system 140. The mounting support 100, as illustrated, is a square structure, such as the one illustrated at FIGS. 2-5. The mounting support 100 typically comprises a pair of horizontal supports 110, a pair of vertical members 120 fixed at an angle to the horizontal supports 110, and at least one traverse member 130 attached between the vertical members 120 and/or other travers members 132 attached between the horizontal support members 110. The horizontal support member 130 may further comprise attachment members or fasteners 134 to receive and hold the box 300 or other attachable assembly. In further embodiments, the mounting support 100 may further comprise support plates 112 and reinforcement members 114.

The system 20 further comprises a lower supporting structure 500 providing support and allowing the system 20 to be self-supported. In such embodiment, the lower supporting structure 500 comprises two side frames 510 attached one to another by a horizontal support member 520. In such embodiments, the side frame 510 comprises horizontal members 512 and vertical members 514 attached to one another using support plates 516 may be shaped as a triangle. The lower supporting structure 500 is attached to the vertical support members 200 to form a self-supporting structure. Understandably, any other design or configuration to form a self-supporting structure may be used and is within the scope of the present invention. The vertical support members 200 are generally attached to the lower supporting structure 500 to allow the aperture 212 to be accessible to mount any structure, such as the mounting support 100.

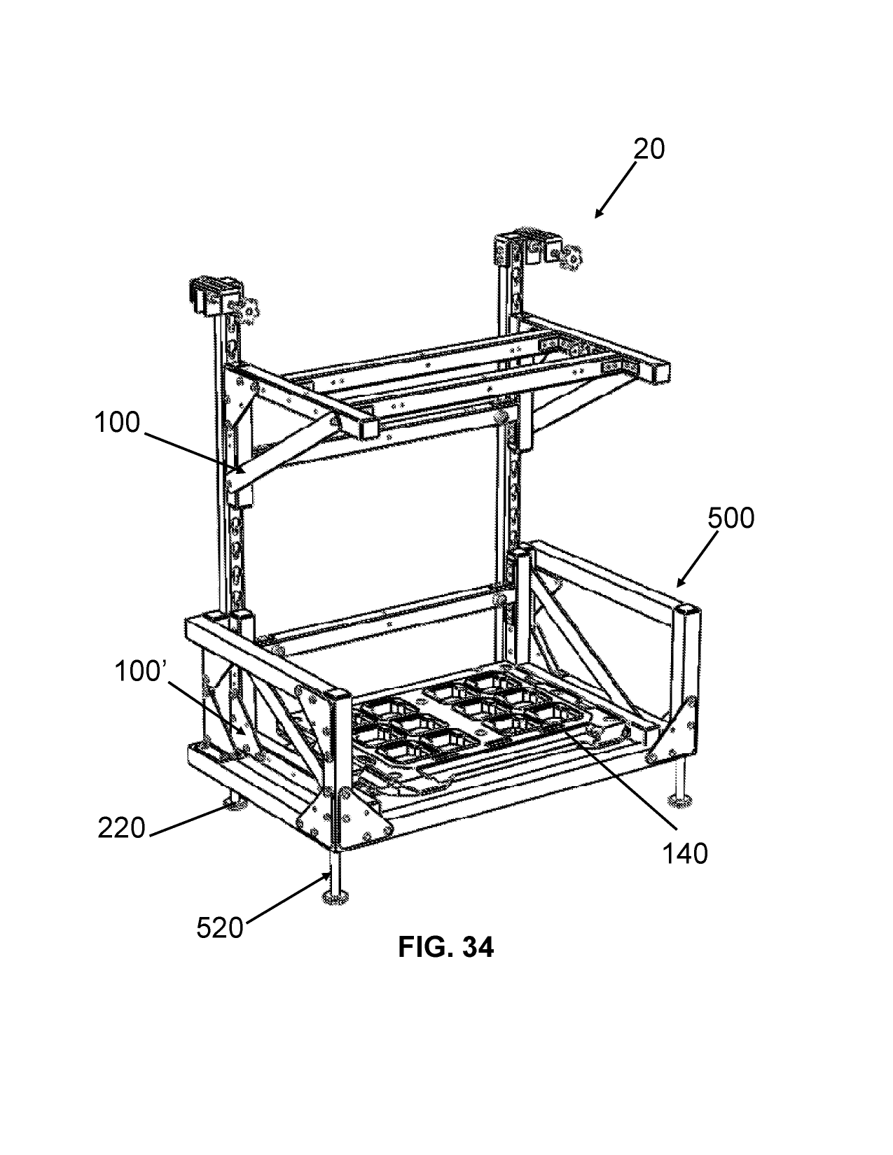

In some embodiments, a mounting support 100 as illustrated at FIGS. 2-5 and as described above is attached to the vertical support members 200. Referring now to FIG. 34, the mounting support 100 may be attached upside down to the vertical support assemblies 400 to allow a higher platform or work area.

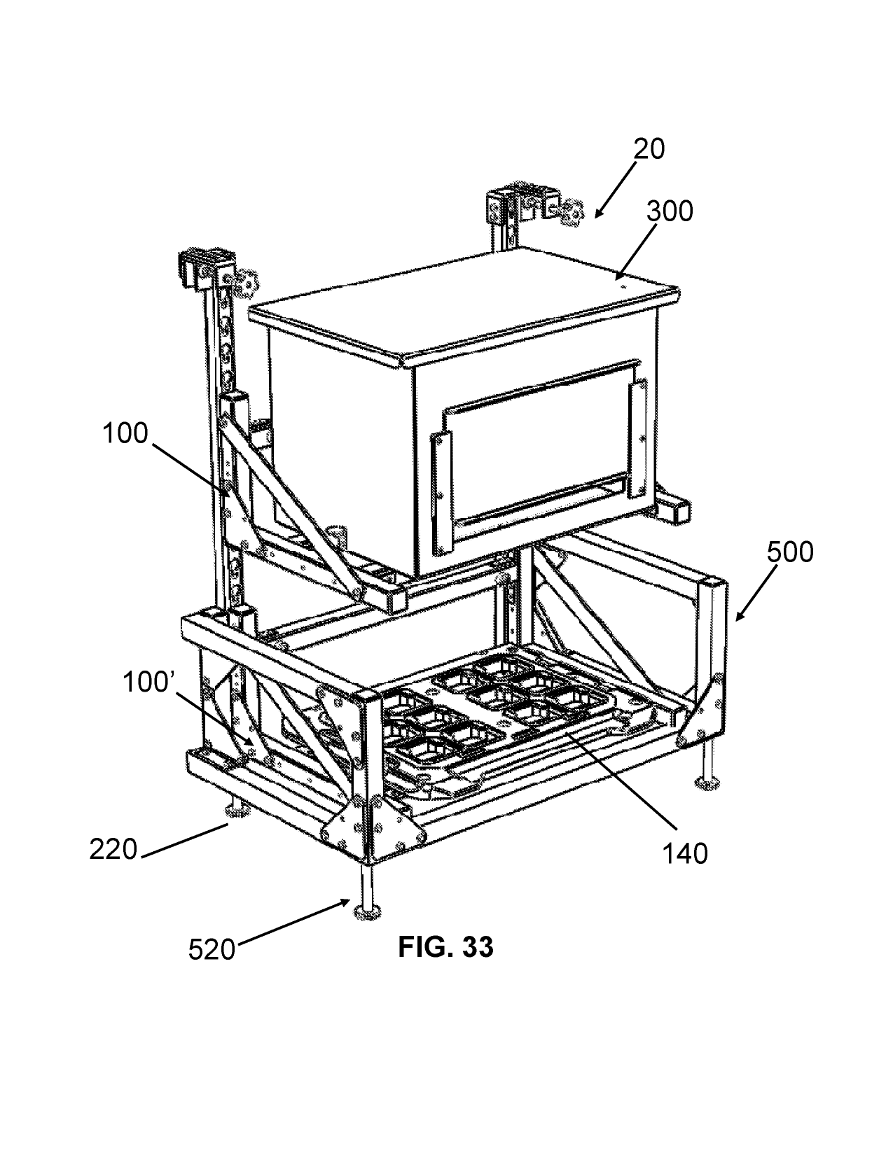

Referring now to FIG. 33, an embodiment of the self-supporting modular tool storage system for aerial lift platforms 20 is illustrated with a storage box 300 mounted over a mounting support 100 and a standard connecting system 140 mounted to another mounting support 100’ suspending or mounted to the system 20 underneath the first mounting support 100. Understandably, any other type of connecting system 140 may be mounted to the self-supporting structure 500.

Referring now to FIG. 34, another embodiment of the self-supporting modular tool storage system for aerial lift platforms 20 is illustrated with a first mounting support 100 and a standard connecting system 140 mounted to a second mounting support 100’ suspending or mounted to the system 20 underneath the first mounting support 100. As described above, the first mounting support 100 is attached upside compared to the second mounting support 100’.

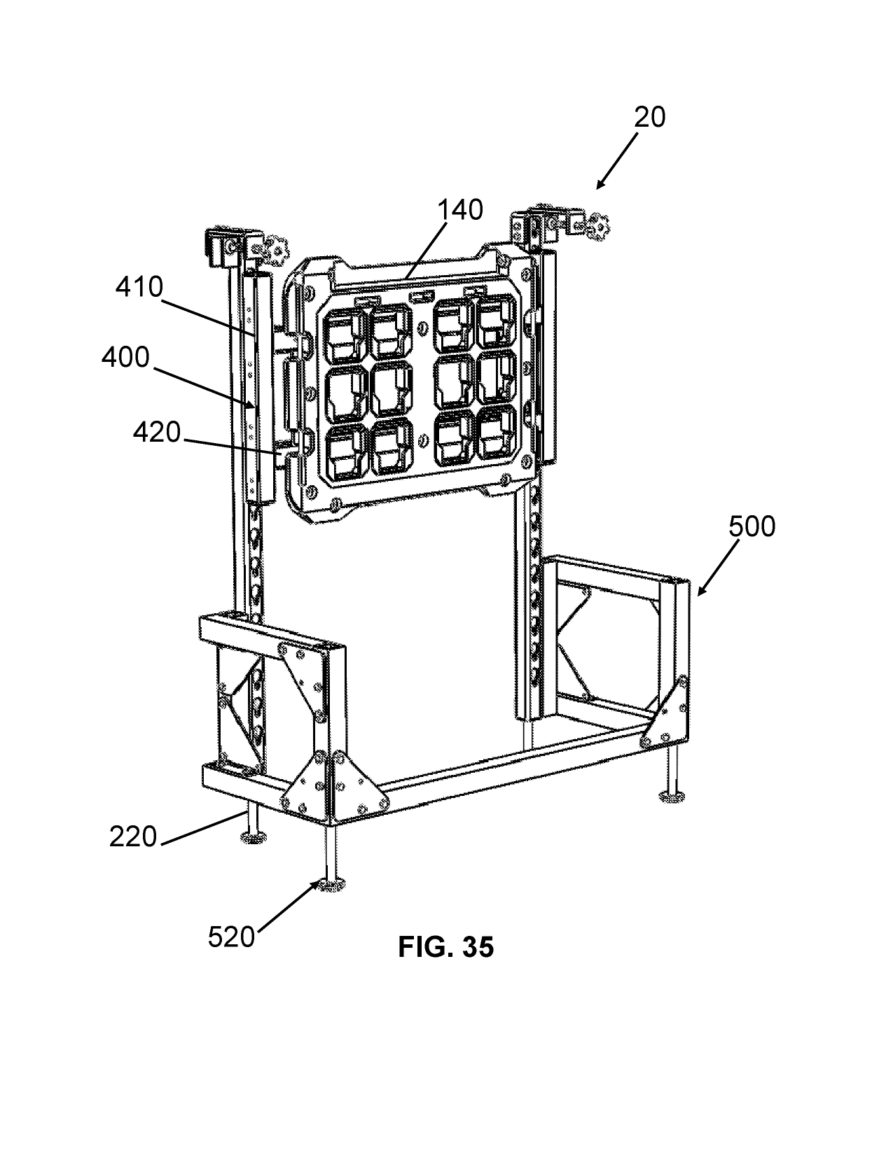

Referring now to FIG. 35, another embodiment of the self-supporting modular tool storage system for aerial lift platforms 20 is illustrated with a vertical mounting support 400. A vertical mounting support 400 as illustrated at FIGS. 24-27 may be mounted to the legs 200 using the vertical members 410 The tool connector assembly 140 may be attached to the horizontal members 420. This configuration is particularly useful in scenarios where a vertical orientation of the storage system is preferred, allowing for better accessibility and use of space within the lift platform 1.

In the illustrated embodiment, the self-supporting modular tool storage system 20 comprises four (4) supports on the platform, such as legs or foots 220/520, two foots 220 extending from the vertical mounting supports 400 and foots 520 extending from the side frames 510 of the lower supporting structure 500. In some embodiments, the foots 220/520 may be vertically adjusted to level the system 20 or to provide added stability on the platform of the pod.

Still referring to FIGS. 32-35, in some embodiments, the system 20 comprises mounting brackets 240 adapted to retain the structure 20 to the rails or other portion of the lift pod. The mounting bracket 240 may be the as the bracket illustrated at FIGS. 20 and 21. The bracket 240 generally aim at providing stability and avoiding the structure to move when the lift is moved or vibrates.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A modular storage system for an aerial lift platform comprising:
a self-supporting lower structure comprising at least two legs adapted to sit on a floor of the aerial lift platform;
two vertical support members extending from the self-supporting lower structure; and
at least one support assembly detachably attached to the two vertical support members.

2. The modular storage system of claim 1, the support assembly comprising a frame which comprises an attachment member mating with an attachment member of the vertical support member.

3. The modular storage system of claim 2, the attachment member of the frame being a head pin protruding away from a vertical member of the support assembly and the attachment member of the vertical support member being an aperture adapted to receive and retain the head pin.

4. The modular storage system of claim 2 further comprising a storage box mounted to the support assembly.

5. The modular storage system of claim 4, the storage box comprising:
a frame;
side walls attached to the frame;
a cover; and
a front door.

6. The modular storage system of claim 1, the self-supporting lower structure comprising two side frames attached one to another by a horizontal support member, the two side frames being attached to the two vertical support members.

7. The modular storage system of claim 6, the two side frames being attached to the two vertical support members to allow attachment member of the vertical support members to be accessible to mount the support assembly.

8. The modular storage system of claim 1 further comprising a second support assembly mounted to the two vertical support members over or under the first support assembly.

9. The modular storage system of claim 1 further comprising mounting brackets adapted to retain the modular storage system to rails or other portion of the aerial lift platform.

10. The modular storage system of claim 1, the support assembly comprising an underneath hanging attachment assembly fixed to sides of support assembly.

11. The modular storage system of claim 10, the underneath hanging attachment assembly comprising an attachment bracket mounted to a horizontal support of the support assembly forming a passage between a lower portion of the horizontal support and the bracket.

12. The modular storage system of claim 1, the support assembly being square and comprising a reinforcement member attached at a horizontal support and a vertical support.

13. A modular storage system for an aerial lift platform comprising:
two vertical support members adapted to be supported by the aerial lift platform;
mounting brackets adapted to mount the vertical support members to rails or other portion of the aerial lift platform; and
at least one support assembly detachably attached to the two vertical support members.

14. The modular storage system of claim 13, the support assembly comprising a frame which comprises an attachment member mating with an attachment member of the vertical support member.

15. A method for storing tools and/material on an aerial lift platform comprising:
disposing a self-supporting storage system on a surface of the aerial lift platform;
detachably mounting a support assembly to vertical support assemblies of the self-supporting storage system; and
storing the tools or materials on the support assembly.

16. The method of claim 15 further comprising detaching the mounted support assembly and attaching the detached mounted support assembly to another predetermined position of the vertical support assemblies.

17. The method of claim 15 further comprising detachably mounting a second support assembly to the vertical support assemblies over or under the mounted support assembly.

18. The method of claim 15 further comprising mounting the vertical support assemblies to rails or other portion of the aerial lift platform.

19. The method of claim 18, the mounting of the vertical support assemblies using mounting brackets attachable to the rails or other portion of the aerial lift platform.
